(19) United States
(12) Patent Application Publication
(10) Pub. No.: US 2009/0244570 A1
(43) Pub. Date: Oct. 1, 2009

(54) Face image-output control device, method of controlling output of face image, program for controlling output of face image, and printing device

(75) Inventor: Hiroyuki Tsuji, Kagoshima-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/383,691

(22) Filed: Mar. 27, 2009

(30) Foreign Application Priority Data
Mar. 27, 2008 (JP) 2008-084248

(51) Int. Cl. G06F 15/00; G06K 9/46; G06K 9/62

(52) U.S. Cl. 358/1.9; 382/195; 382/156; 382/103

(57) ABSTRACT

A face image-output control device includes a face image detecting unit that detects a face image positioned in an approximately front direction from a target image and an output control unit that outputs the target image and a predetermined mark indicating that a face image of the target image can be printed as an identification photograph to a predetermined output target for a case where the face image positioned in an approximately front direction is detected by the face image detecting unit.

### BACKGROUND

1. Technical Field

The present invention relates to a face image-output control device, a method of controlling output of a face image, a program for controlling output of a face image, and a printing device.

2. Related Art

There is a case where users print an identification photograph (for example, an ID photo that is used for a resume, a driver's license, a passport, or the like) by using printers. As technology related thereto, a printing device in which a user selects an ID photo mode from a selection screen of a print mode, then, selection of the type of a printing sheet and the size of an ID photo is received from the user, selection of an image to be printed as the ID photo is received from the user, then, a face area is extracted from the selected image, an area (clip area) including the extracted face area which will be printed as the ID photo is determined, and an image of the clip area is printed on the selected printing sheet has been known (see JP-A-2007-253488).

In JP-A-2007-253488, the user selects the ID photo mode by operating an operation panel with a display watched, sequentially checks a plurality of images that are read out from a memory card to be displayed in the display, and selects an image desired to be printed as an ID photo. However, to determine whether an image is appropriate as an ID photo by checking contents of images that are photographed and stored in the memory card one after another is a heavy load for the user. In particular, when a plurality of images is saved in the memory card, a load needed for the determination is increased further. In addition, when a plurality of face images is included in one image, the user may hesitate to determine a face image that is appropriate as the ID photo.

### SUMMARY

An advantage of some aspects of the invention is that it provides a face image-output control device, a method of controlling output of a face image, a program for controlling output of a face image, and a printing device capable of relieving a user's load in the process of printing an ID photo.

According to a first aspect of the invention, there is provided a face image-output control device including: a face image detecting unit that detects a face image positioned in an approximately front direction from a target image; and an output control unit that outputs the target image and a predetermined mark indicating that a face image of the target image can be printed as an identification photograph to a predetermined output target for a case where the face image positioned in an approximately front direction is detected by the face image detecting unit. According to the face image-output control device, it is determined whether a face image positioned in an approximately front direction exists in the target image. When a face image positioned in an approximately front direction exists (when a face image positioned in an approximately front direction is detected), the predetermined mark is output together with the target image. Accordingly, a user can recognize whether a face image appropriate as an ID photo exists in the target image instantly by seeing the predetermined mark. Therefore, selection of an image can be performed in an easy manner.

In the above-described face image-output control device, the output control unit may be configured to select one face image from among a plurality of detected face images based on a predetermined reference and output a predetermined mark indicating that the selected face image can be printed as an identification photograph in a case where the plurality of face images positioned in an approximately front direction is detected by the face image detecting unit. In such a case, even when a plurality of face images positioned in an approximately front direction exists in the target image, the predetermined mark is output for one face image. Accordingly, the user does not need to hesitate to determine a face image to be printed as an ID photo. As a detailed example for such a case, the output control unit may be configured to select a face image, which has a maximum size, from among the plurality of face images positioned in an approximately front direction which are detected by the face image detecting unit. In such a case, the user can recognize that a face image, which has a maximum size, from among the plurality of face images positioned in an approximately front direction, which exists in the target image, is to be printed as an ID photo instantly.

In the above-described face image-output control device, the output control unit may be configured to output the target image and the predetermined mark in a predetermined screen and output a trimming frame that defines a trimming range on the target image and can be moved, enlarged, or reduced in accordance with an external operation to the screen for a case where selection of a predetermined mark is received. In such a case, when the predetermined mark is output to the screen, the user can display the trimming frame on the screen by selecting the predetermined mark. Thereafter, by directing the movement, enlargement, or reduction of the trimming frame, a range of the target image to be printed as the ID photo can be determined.

In the above-described face image-output control device, the output control unit may be configured to print the target image and the predetermined mark on a printing medium. In such a case, the user can acquire so-called an order sheet in which the target image and the predetermined mark are printed on one printing medium.

In the above-described face image-output control device, the face image detecting unit may be configured to perform the detection by using a neural network that receives information on an image within a detection window that is set in the target image and outputs information indicating existence or non-existence of a face image positioned in an approximately front direction. In such a case, by using the neural network, whether a face image positioned in an approximately front direction exists can be determined with high accuracy.

The technical idea of the invention may be conceived as a method of controlling output of a face image that includes the processing steps performed by the units of the above-described face image-output control device or a program for controlling output of a face image that allows a computer to perform functions corresponding to the units of the above-described image-output control device, in addition to the above-described face image-output control device. In addition, the invention may be conceived as a printing device including: a face image detecting unit that detects a face image positioned in an approximately front direction from a target image; and an output control unit that outputs the target image and a predetermined mark indicating that a face image of the target image can be printed as an identification photograph to a predetermined output target for a case where the face image positioned in an approximately front direction is detected by the face image detecting unit.

### BRIEF DESCRIPTION OF THE DRAWINGS

The invention will be described with reference to the accompanying drawings, wherein like numbers reference like elements.

FIG. 1 is a schematic block diagram showing the configuration of a printer according to an embodiment of the invention.

FIG. 2 is a flowchart showing a process that is performed by the printer.

FIG. 3 is a flowchart showing a detailed face image detecting process according to an embodiment of the invention.

FIG. 4 is a diagram showing the appearance of setting a detection window according to an embodiment of the invention.

FIG. 5 is a diagram showing the appearance of calculating characteristic amounts based on window image data according to an embodiment of the invention.

FIG. 6 is a diagram showing an example of the structure of a neural network according to an embodiment of the invention.

FIG. 7 is a schematic diagram showing the appearance of building a neural network by learning according to an embodiment of the invention.

FIG. 8 is a diagram showing an example of an image that is output in a display unit according to an embodiment of the invention.

FIG. 9 is a diagram showing another example of an image that is output in a display unit according to an embodiment of the invention.

FIG. 10 is a diagram showing the appearance of setting a trimming frame on a target image, according to an embodiment of the invention.

FIG. 11 is a diagram showing an example of an order sheet according to an embodiment of the invention.

FIG. 12 is a schematic diagram showing a front-face existence determining process according to an embodiment of the invention.

FIG. 13 is a diagram showing determination characteristics of the front-face existence determining process.

### DESCRIPTION OF EXEMPLARY EMBODIMENTS

An embodiment of the invention will be described in the following order.

1. Schematic Configuration of Printer

2. Output Process of ID Photo Printing Mode UI

3. Process after Transition to ID Photo Printing mode

4. Modified Example

### 1. Schematic Configuration of Printer

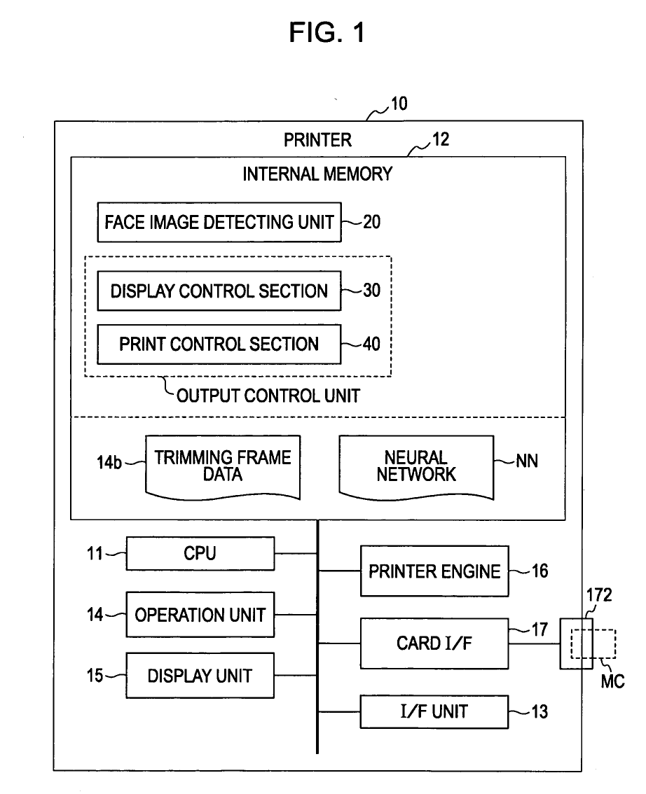

FIG. 1 schematically shows the configuration of a printer 10 as an example of a face image-output control device and a printing device according to an embodiment of the invention. The printer 10 prints an image based on image data that is acquired from a recording medium (for example, a memory card MC or the like) and is a color ink jet printer corresponding to so-called direct printing. The printer 10 includes a CPU 11 that controls other units of the printer 10, an internal memory 12 that is, for example, configured by a ROM and a RAM, and operation unit 14 that is configured by buttons or a touch panel, a display unit 15 that is configured by a liquid crystal display, a printer engine 16, a card interface (card I/F) 17, and an I/F unit 13 for exchanging information with external devices such as a PC, a server or a digital still camera. The constituent elements of the printer 10 are interconnected through a bus. The display unit 15 corresponds to an example of a predetermined output target according to an embodiment of the invention.

The print engine 16 is a printing mechanism that performs a printing operation based on print data. The card I/F 17 is an I/F used for exchange data with the memory card MC that is inserted into a card slot 172. In the memory card MC, image data is stored, and the printer 10 can acquire the image data that is stored in the memory card MC through the card I/F 17. As a recording medium used for providing the image data, various media other than the memory card MC can be used. It is apparent that the printer 10 can receive the image data as an input from the external devices, other than the recording medium, that are connected thereto through the I/F unit 13. The printer 10 may be a printing device that is dedicated for consumer use or may be an office printing device (so called a mini laboratory device) that is dedicated for DPE. The operation unit 14 and the display unit 15 may be an input operation unit (a mouse, a keyboard, or the like) or a display that is configured separated from a printer 10 main body. The printer 10 may receive the print data as an input from a PC or a server that is connected thereto through the I/F unit 13.

In the internal memory 12, a face image detecting unit 20, a display control section 30 and a print control section 40 are stored. The face image detecting unit 20 is a computer program that is used for performing a process for detecting a face image positioned in an approximately front direction to be described later under a predetermined operating system. The display control section 30 is a computer program for acquiring or generating an image such as a user interface (UI) image, which is used for receiving various directions from a user, a message, a thumb-nail image, or the like, to be output (displayed) in the display unit 15. In addition, the display control section 30 is also a display driver that controls the display unit 15 to display the UI image, the message, the thumb-nail image, or the like in a screen of the display unit 15. The print control section 40 is a computer program for generating the print data based on the image data and controls the printer engine 16 to print an image in a printing medium based on the print data. In addition, the print control section 40 controls the printer engine 16 to print an order sheet to be described later. The display control section 30 and the print control section 40 correspond to an example of an output control unit according to an embodiment of the invention.

The CPU 11 implements the function of each of these units by reading out the program from the internal memory 12 and executing the program. In addition, in the internal memory 12, various types of data and programs such as trimming frame data 14b and neural network NN are stored. The printer 10 may be a multi-function device that has various types of functions such as a copy function, a scanner function (image reading-out function), in addition to the print function.

### 2. Output Process of ID Photo Printing Mode UI

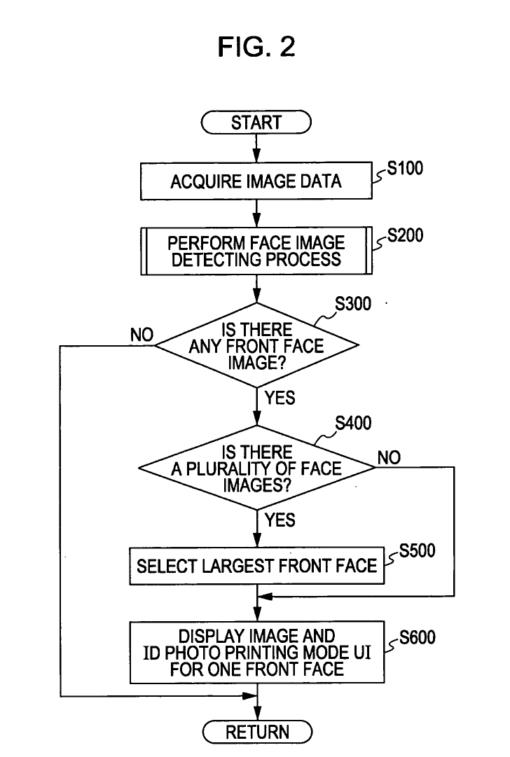

FIG. 2 is a flowchart showing an output process of an ID photo printing mode UI that is performed by the printer 10. When a recording medium is inserted into the card slot 172, the printer 10 receives an image stored in the recording medium as input and displays the input image in the display unit 15 by using the display control section 30. Alternatively, when an image is input from the external device that is connected to the printer 10 through the I/F unit 13, the printer 10 displays the input image in the display unit 15 by using the display control section 30. The display unit 15 displays the input image in units of one sheet or displays a list of a plurality of input images. According to this embodiment, the output process of the ID photo printing mode UI is performed in a scene in which the image is output to the display unit 15 as described above.

In Step (hereinafter, notation of “Step” will be omitted) S100, the face image detecting unit 20 acquires image data D representing an image (target image) of one sheet to be processed from the recording medium or the external device, or the like. The image data D is bit map data that is formed from a plurality of pixels. Each pixel is represented as a combination of gray scales (for example, 256 gray scales of “0” to “255”) of RGB channels. The image data D may be compressed in a stage being recorded in a recording medium or the like, and colors of the pixels may be represented in a different color space. In such a case, the face image detecting unit 20 acquires the image data D as the RGB bit map data by expanding the image data D or performing conversion of the color space.

In S200, the face image detecting unit 20 detects a face image positioned in an approximately front direction from the image data D. The face image positioned in an approximately front direction described in this embodiment includes not only a face image of which the face direction faces the exact front side in the target image but also a face image, of which the face direction slightly inclines horizontally or vertically and all the face organs (left and right eyes, a nose, and a mouth) face almost the front side, to be able to be used as an ID photo without any problem. Hereinafter, a face image positioned in an approximately front direction is simply referred to as a front face. Any technique can be employed by the face image detecting unit 20 in S200 as long as it can detect a front face from the image data D. In this embodiment, detection is performed, for example, by using a neural network NN.

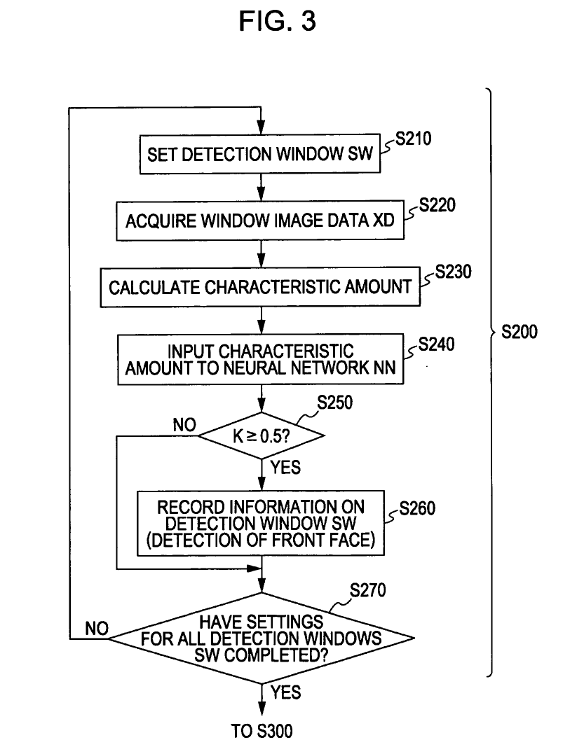

FIG. 3 is a flowchart showing a detailed process of S200.

In S210, the face image detecting unit 20 sets one detection window SW for the image data D. The detection window SW is an area located on the image data D and becomes a target for detecting (determining existence of) a front face. In addition, the face image detecting unit 20 may be configured to reduce the size of the image data D before performing the process of S210. When detection of a front face is performed for the image data D of an original image size as a target, the process load is heavy. Thus, the face image detecting unit 20 reduces the image size of the image data D by decreasing the number of pixels of the image data or the like, and the process of S210 and thereafter is performed for the image data D after reduction as the target. The face image detecting unit 20, for example, reduces the image data D into a size (320 pixels×240 pixels) of QVGA (Quarter Video Graphics Array). Moreover, the face image detecting unit 20 may convert the image data D into a gray image before performing the process of S210. The face image detecting unit 20 converts the RGB data of each pixel of the image data D into a brightness value Y (0 to 255) and generates image data D as a monochrome image having one brightness value Y for each pixel. Generally, the brightness value Y can be calculated by adding R, G, and B together with predetermined weighting factors applied. The conversion of the image data D into a gray image is performed in advance in consideration of alleviation of the load at the time of calculating characteristic amounts to be described later. A method of setting the detection window SW is not particularly limited. However, as an example, the face image detecting unit 20 sets the detection window DW as below.

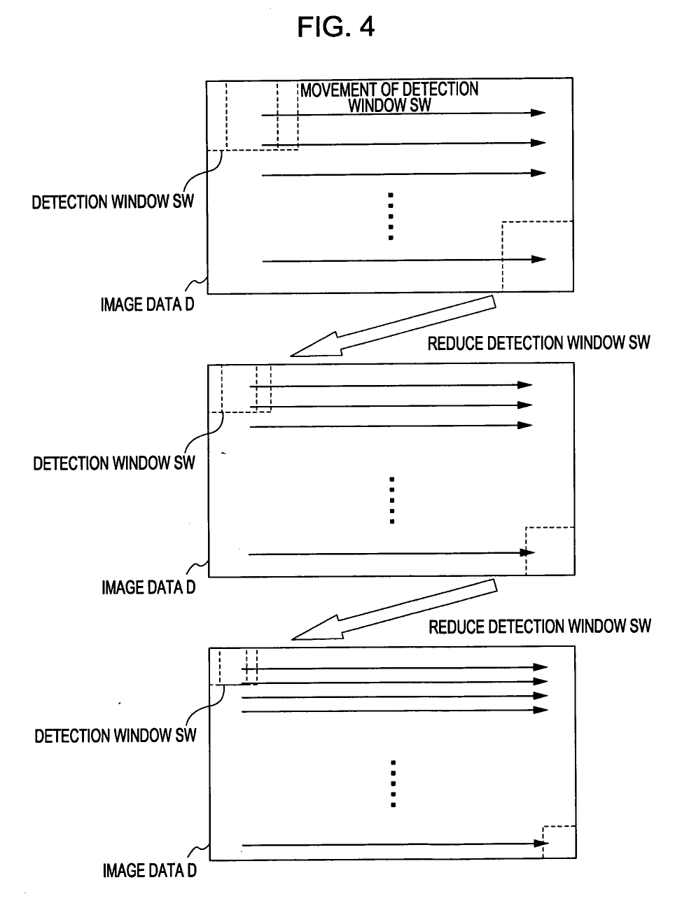

FIG. 4 shows the appearance of setting the detection window SW for the image data D. The face image detecting unit 20, in S210 for the first time, sets a detection window SW (denoted by a dashed-two dotted line) of a rectangular shape having a predetermined size including a plurality of pixels in a leading position (for example, a position located on the upper left corner of the image) within the image. Then, the face image detecting unit 20, in S210 for the second time and thereafter, moves the detection window SW from the position in which the detection window SW is set until then in the horizontal direction of the image or the vertical direction of the image by a predetermine distance (a predetermined number of pixels) and newly sets one detection window SW in the moved position. After repeatedly setting the detection window SW while moving the detection window SW to a final position (for example, a position located on the lower right corner of the image) of the image data D with the size of the detection window SW maintained, the face image detecting unit 20 sets the detection window SW back in the leading position.

When returning the detection window SW to the leading position, the face image detecting unit 20 sets a detection window SW of which the size of the rectangular is smaller than that up to that time. Thereafter, the face image detecting unit 20, same as described above, sets the detection window SW in each position while moving the detection window SW up to the final position of the image data D with the size of the detection window SW maintained. The face image detecting unit 20 repeats such movement and setting of the detection window SW while gradually reducing the size of the detection window SW for the number of times determined in advance. As described above, when one detection window SW is set in S210, the process of S220 and thereafter is performed.

In S220, the face image detecting unit 20 acquires image data (window image data) XD formed of pixels within the detection window SW which is set as the image data D in the previous S210.

In S230, the face image detecting unit 20 calculates a plurality of characteristic amounts based on the window image data XD acquired in the previous S220. These characteristic amounts can be acquired by applying various filters to the window image data XD and calculating characteristic amounts (an average value, a maximum value, a minimum value, and a standard deviation of brightness) that represent image characteristics such as an average brightness value, an edge amount, and contrast within the filters.

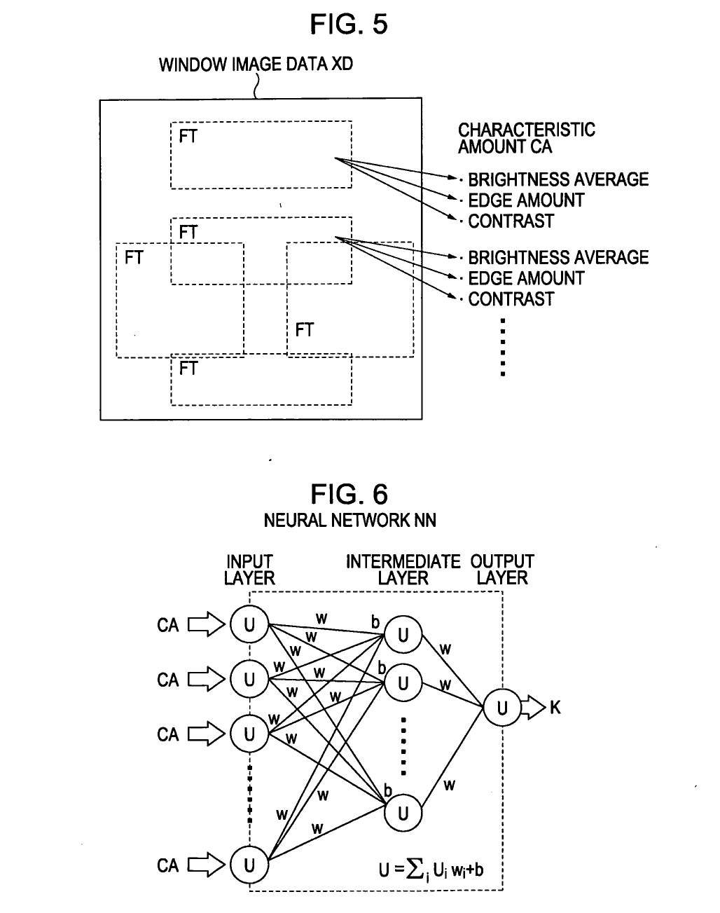

FIG. 5 shows the appearance of calculating the characteristic amounts based on the window image data XD. In the figure, a plurality of filters FT having different relative sizes and positions with respect to the window image data XD is prepared. Thus, by sequentially applying the filters FT to the window image data XD, a plurality of characteristic amounts CA, CA, CA . . . is calculated based on the image characteristics within the filters FT. In FIG. 5, each rectangular within the window image data XD is referred to as a filter FT. When the characteristic amounts CA, CA, CA . . . are calculated, the face image detecting unit 20 inputs the characteristic amounts CA, CA, CA . . . to a neural network NN prepared in advance in S240. Then, the result of determination on existence or non-existence of a front face is made based on the output of the neural network NN.

FIG. 6 shows an example of the structure of the neural network NN. The neural network NN has a basic structure in which a value of a unit U of the latter-level layer is determined based on a linear combination (here, a subscript i is an identification number of a unit U of the former-level layer) of values of units U of the former-level layer. In addition, the value that is acquired by the linear combination may be directly set as a value of the unit U of the next layer. However, a non-linear characteristic may be implemented by determining the value of the unit U of the next layer by converting the value that is acquired by the linear combination using a non-linear function such as a hyperbolic tangent function. The neural network NN is configured by an outermost input layer, an output layer, and an intermediate layer that is interposed between the input layer and the output layer. The characteristic amounts CA, CA, CA . . . can be input to the input layer of the neural network NN, and the output layer can output an output value K (a value normalized between 0 and 1). In S250, for example, when the output value K of the neural network NN is equal to or larger than 0.5, the face image detecting unit 20 determines that the output value is a value representing existence of a front face in the window image data XD, and the process proceeds to S260. On the other hand, when the output value K is smaller than 0.5, the face image detecting unit 20 determines that the output value is a value representing non-existence of a front face in the window image data XD, and the process proceeds to S270.

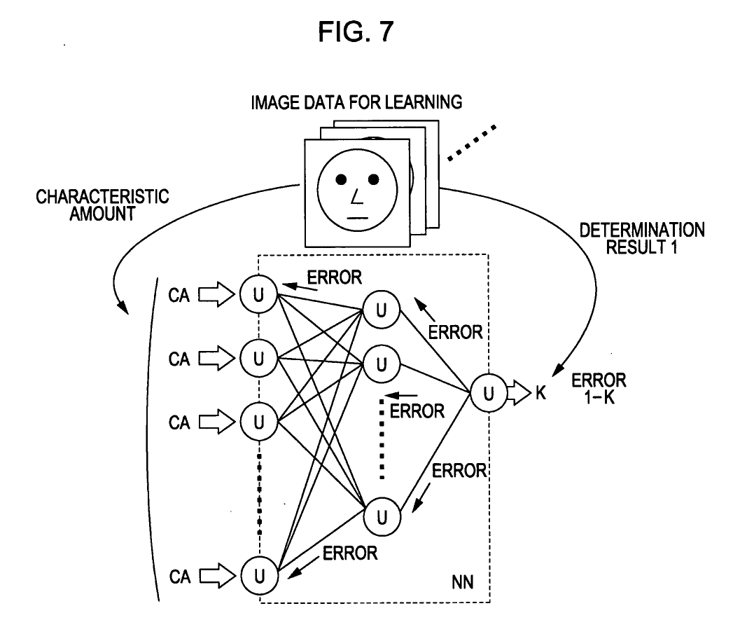

FIG. 7 schematically shows the appearance of building the neural network NN by learning. In this embodiment, by performing learning of the neural network NN by using an error back propagation method, the number of units U, the magnitudes of the weighting factors w for linear combination of the units U, and the value of a bias b are optimized. In learning by using the error back propagation method, first, the magnitudes of the weighting factors w for linear combination of the units U and the value of the bias b are initially set to appropriate values. Then, in determining whether a front face exists, for the known learning image data, the characteristic amounts CA, CA, CA . . . are calculated in the order of S230 and S240, the characteristic amounts CA, CA, CA . . . are input to the initially set neural network NN, and the output value K is acquired. In this embodiment, it is preferable that “1” is output as the output value K for the learning image data in which a front face exists. In addition, it is preferable that “0” is output as the output value K for the learning image data (for example, image data in which a side face exists, image data in which a turned-up face exists, image data in which a turned-down face exists, image data in which a subject other than a person's face exists, or the like) in which a front face does not exist.

However, the magnitudes of the weighting factors w and the value of the bias b for linear combination of the units U are only initially set to appropriate values. Thus, there is an error between an output value K that is acquired by inputting the characteristic amounts CA, CA, CA . . . of the learning image data and an ideal output value K (1 or 0). The weighting factors w for the units U and bias b for minimizing such an error are calculated by using a numerical optimizing technique such as a gradient technique. The above-described error propagates from the latter-level layer to the former-level layer, and thus, the weighting factors w and the bias b for the latter-level units U are sequentially optimized. By preparing the neural network NN that is optimized by performing learning by using a plurality of the learning image data inside the internal memory 12 in advance, it can be determined whether a front face exists in the window image data XD based on the characteristic amounts CA, CA, CA . . . .

When it is determined that a front face exists in the previous S250 (“Yes” in S250), the face image detection unit 20 associates the position of the detection window SW (for example, the center position of the detection window SW in the image data D) and the size (magnitude) of the rectangle of the detection window SW with the image data D acquired in S100 and then, records the position of the detection window SW and the size of the rectangle in a predetermined area of the internal memory 12. As described above, the operation of recording information such as the position, the size, and the like of the detection window SW in which a front face is determined to exist corresponds to an example of detecting a front face.

In S270, under the idea of the method of setting the detection window SW which is described with reference to FIG. 4, the face image detecting unit 20 moves the detection window SW and reduces the size of the detection window SW further. Then, when there is room for setting the detection window SW still, the process returns back to S210, and one detection window SW is newly set in the image data D. On the other hand, when all the settings for the detection windows SW which can be made are completed by repeating reduction of the detection window SW for the predetermined-number of times, the face image detecting unit 20 ends the process of S200. As a result, detection of a front face (a plurality of front faces for a case where the plurality of front faces exists) in the image data D is completed.

In S300 (FIG. 2), the display control section 30 branches the process based on whether a front face exists in the image data D acquired in S100. When the information such as the position of the detection window SW in the image data D is recorded in the internal memory 12, the display control section 30 determines that a front face exists, and the process proceeds to S400. On the other hand, when any information on the detection window SW of the image data D is not recorded in the internal memory 12, the display control section 30 determines that any front face does not exist in the image data D and ends the process shown in the flowchart of FIG. 2.

In S400, the display control section 30 branches the process based on whether a plurality of front faces exists in the image data D acquired in S100. When the information on the detection window SW of the image data D is recorded in the internal memory 12 for a plurality of detection windows SW, the display control section 30 determines that a plurality of front faces exists, and the process proceeds to S500. On the other hand, when the information on the detection window SW of the image data D is recorded in the internal memory 12 for one detection window SW only, the display control section 30 determines that only one front face exists in the image data D, and the process proceeds to S600.

In S500, the display control section 30 selects one front face from among the plurality of front faces existing in the image data D, which is acquired in S100, based on a predetermined reference. Here, one front face that is the most appropriate to be printed as an ID photo is selected. In particular, the display control section 30 selects one detection window SW having a maximum size with reference to the information on the plurality of detection windows SW which is associated with the image data D and is recorded in the internal memory 12. As a result, one front face (a detection window SW in which a front face exists) is selected from the plurality of front faces existing in the image data D.

In S600, the display control section 30 simultaneously displays an image (target image) represented by the image data D that is acquired in S100 and the ID photo printing mode UI for one front face on a screen of the display unit 15. One front face described here means the front face that is selected in S500 or one front face for a case where only the one front face exists in the image data D.

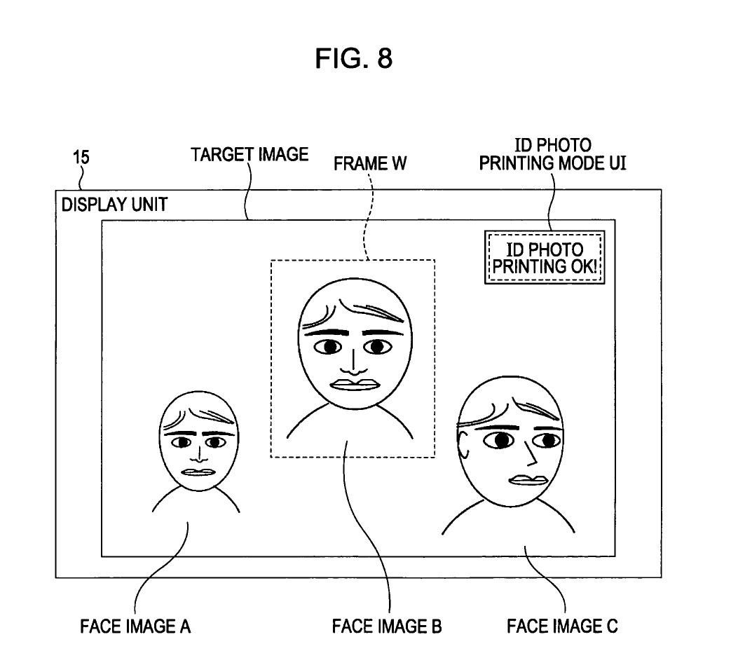

FIG. 8 shows an example of an image that is displayed in the display unit 15 by the display control section 30 in S600. As shown in FIG. 8, in the display unit 15, a target image (basically a thumbnail image of the target image) that is displayed based on the image data D and the ID photo printing mode UI that is represented by “ID photo printing OK!” or the like are displayed. The target image displayed in the display unit 15 may be a color image or a monochrome image. The ID photo printing mode UI is a predetermined mark indicating that the face image included in the target image can be printed as an ID photo and is also UI that receives a direction for transition to the ID photo printing mode. The display control section 30 acquires image data representing the ID photo printing mode UI which is saved in the internal memory 12 or the like in advance and displays the ID photo printing mode UI in the display unit 15 based on the acquired image data. The ID photo printing mode UI, for example, is overlapped with a corner of the target image to be displayed in the display unit 15. FIG. 8 shows an example in which three face images A to C exist in the target image. Among the face images A to C, the face image C has the appearance of a face facing the side (not a front face), and accordingly, the face image C is not detected in the face image detecting process of S200. In addition, both the face images A and B are front faces, and accordingly; the face images A and B are detected in the face image detecting process of S200. Of the face images A and B, the face image B is the larger, and accordingly, the face image B is selected in S500.

When a plurality of front faces is detected from the target image, the display control section 30 also displays a mark indicating a user that the front face selected in S500 becomes a target to be printed as the ID photo in the display unit 15. For example, as shown in FIG. 8, the display control section 30 clarifies the front face that becomes the target to be printed as the ID photo by displaying a frame W surrounding the selected front face (face image B) based on the information of the position and the magnitude of the detection window SW corresponding to the front face selected in S500. In other words, in the example shown in FIG. 8, the ID photo printing mode UI is in correspondence with the face image B. Alternatively, the display control section 30 may be configured to have the front face selected in S500 to be distinguished by displaying an area of the target image other than the front face selected in S500 in a light color, painting the area in a white color, a black color, or a gray color, or the like.

When the process of the flowchart shown in FIG. 2 ends as the result of branching in S300 (“No” in S300), the display control section 30 displays the target image that is represented by the image data D acquired in S100 on the screen of the display unit 15. For the target image for which determination of “No” is made in S300, any ID photo printing mode UI is not displayed.

In FIG. 8, a case where one image received from a recording medium or the like is displayed in the display unit 15 has been shown. However, as described above, the display control section 30 may be configured to display a list of a plurality of images that are received from a recording medium or the like.

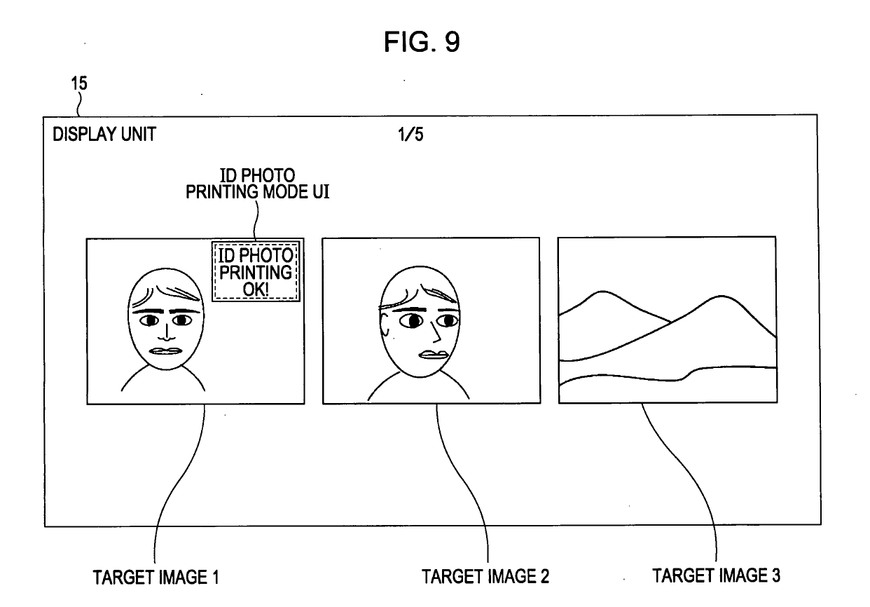

FIG. 9 shows an example in which the display control section 30 displays a list of a plurality of images that are received from a recording medium or the like in the display unit 15. In other words, the printer 10 acquires a plurality of images from a recording medium or the like as target images, performs the process of S100 to S500 for the acquired target images, and then, displays the plurality of target images altogether in the display unit 15. As a result, the ID photo printing mode UI is displayed only for a target image (target image 1 in the example shown in FIG. 9), from which a front face is detected, from among the plurality of target images displayed in the list. In the target image 1 shown in FIG. 9, a case where one front face exists is exemplified.

### 3. Process after Transition to ID Photo Printing Mode

When an ID photo printing mode UI is displayed for a target image in the display unit 15, as described above, a user can have the printer 10 to transit to the ID photo printing mode by selecting the ID photo printing mode UI through the operation unit 14. In other words, when detecting press on the ID photo printing mode UI in the display unit 15 or detecting selection of the ID photo printing mode UI in accordance with an operation of a predetermined button or the like, the printer 10 transits to the ID photo printing mode in which a front face corresponding to the ID photo printing mode UI is printed as an ID photo.

When transited to the ID photo printing mode, the printer 10 may be configured to print the ID photo automatically. In such a case, the print control section 40 extracts an image area of the front face corresponding to the ID photo printing mode UI, which is selected by the user, from the image data D including the front face. In particular, the print control section 40 determines a rectangular area, of which the size ratio with respect to the detection window SW is determined in advance, including the detection window SW on its center from the image data D (the image data D before being converted into a gray image) based on the information (the information on the detection window SW that is saved in the internal memory 12) on the detection window SW corresponding to the front face corresponding to the selected ID photo printing mode UI. Then, the print control section 40 cuts out (trims) the determined rectangular area from the image data D. Then, the print control section 40 appropriately performs pixel-number conversion (enlargement or reduction) for the image data of the cut-out rectangular area in accordance with the size of the ID photo which is set in advance (or set by the user).

The print control section 40 generates print data by performing a needed process such as a color converting process or a half-tone process for the image data after the pixel-number converting process. Then, the print control section 40 allows the printer engine 16 to perform printing based on the print data by supplying the generated print data to the printer engine 16. Accordingly, the printing process in the ID photo printing mode, that is, printing an ID photo having a front face is completed.

When transited to the ID photo printing mode, the printer 10 may allow the user to designate a trimming range without performing all the processes automatically until completion of printing the ID photo. When detecting transition to the ID photo printing mode through the ID photo printing mode UI, the display control section 30 reads out trimming frame data 14b from the internal memory 12. Then, the display control section 30 marks the trimming frame on the target image, in which the ID photo printing mode UI selected by the user is displayed, based on the trimming frame data 14b.

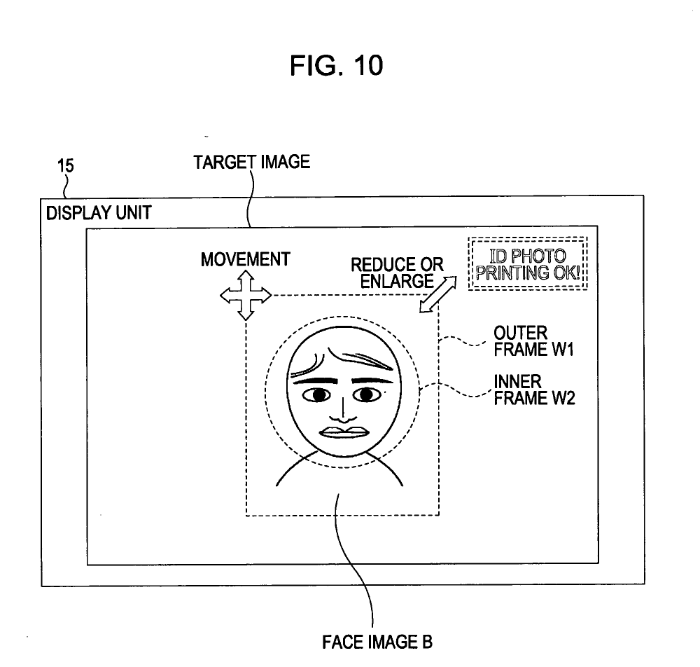

FIG. 10 shows an example of appearance of marking the trimming frame on the target image in the display unit 15. The trimming frame is formed of an outer frame W1 having a rectangular shape and an inner frame W2 having a circular shape that is placed inside the outer frame W1. The default shapes and default sizes of the outer frame W1 and the inner frame W2 and relative positional relationship between the outer frame W1 and the inner frame W2 are defined by the trimming frame data 14b. The user can direct the display control section 30 to move, enlarge, or reduce the trimming frame by operating the operation unit 14. The display control section 30 moves, enlarges, or reduces the trimming frame on the screen of the display unit 15 in accordance with the direction for movement, enlargement, or reduction. The display control section 30 performs movement, enlargement, or reduction of the outer frame W1 and the inner frame W1 such that the relative position and the size relationship of the outer frame W1 and the inner frame W2 are maintained all the time.

The user directs movement, enlargement, or reduction of the trimming frame such that the entire front face (in the example of FIG. 10, the face image B) located on the target image is inside the inner frame W2. Then, when the entire front face is appropriately placed inside the inner frame W2, the user notifies the printer 10 of determination of the trimming range by operating the operation unit 14. When receiving the direction for the determination, the printer 10 cuts out an image area of the trimming frame set on the display unit 15 which is surrounded by the outer frame W1 from the image data D of the target image and performs generation of the print data and printing based on the image data of the cut-out image area as described above. As a result, printing an ID photo having a front face is performed based on the trimming range that is designated by the user.

As described above, according to this embodiment, when succeeded in detecting a front face from the target image, the printer 10 displays the ID photo printing mode UI together with displaying the target image in the display unit 15. In addition, when a plurality of front faces is detected from the target image, a front face having a maximum size is selected from among the plurality of front faces, and the ID photo printing mode UI is displayed in a state in which the selected front face is clarified to be a target for the ID photo printing in the display unit 15. As a result, when a recording medium is inserted into the printer 10 or the like, the user can visually recognize that the target image is an appropriate image to be printed as an ID photo in an easy manner by seeing the target image displayed together with the ID photo printing mode UI in the display unit 15. In addition, even when a plurality of front faces exists in the target image, the user can recognize a front face that can be preferably selected as a target of an ID photo instantly. Accordingly, the user's load for printing an ID photo can be reduced markedly, compared to that of a general case.

### 4. Modified Example

In the description above, it is assumed that an output target of the target image and the predetermined mark indicating that a face image of the target image can be printed as an ID photo is the screen of the display unit 15. However, the output target of the target image and the predetermined mark may be a printing medium (printing sheet). In other words, the printer 10 may be configured to print (output) the target image and the predetermined mark on a printing medium by controlling the printer engine 16 by using the print control section 40, in addition to (or replacing) displaying the ID photo printing mode UI-attached target image in the display unit 15 as a result of performing the process shown in FIG. 2. The user can use the printed material as so-called an order sheet.

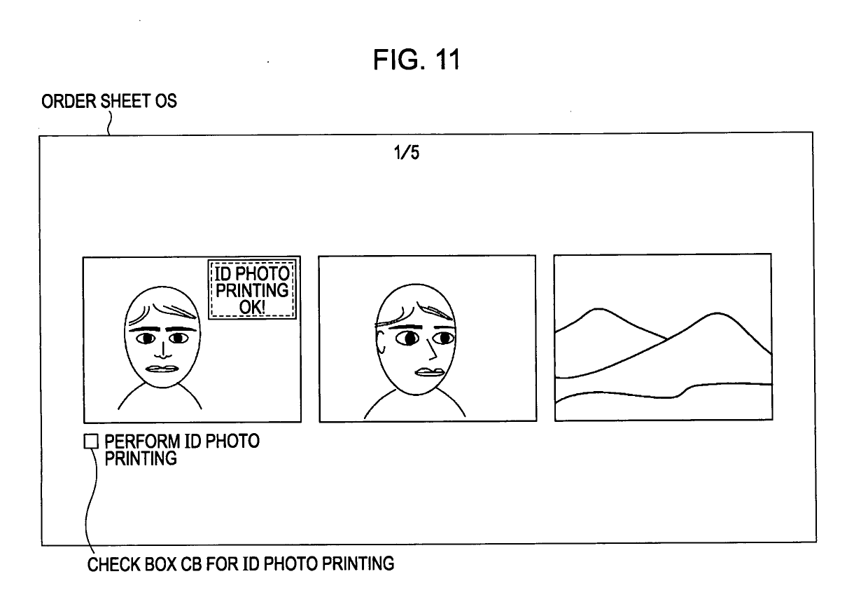

FIG. 11 shows an example of the order sheet OS that is printed by the printer 10. FIG. 11 shows a case where an image corresponding to the image displayed in the display unit 15 shown in FIG. 9 as an example is printed as an order sheet OS. As shown in FIG. 11, in the order sheet OS, an ID photo printing check box CB is printed together with only a target image having a front face. In other words, when printing the order sheet OS, the print control section 40 performs printing with the ID photo printing check box CB arranged near the target image for which a front face is detected. The ID photo printing check box CB is an example of the predetermined mark. The user can write a predetermined mark into the ID photo printing check box CB of the order sheet OS with a pen or the like. Then, for example, the user has the order sheet OS, on which the mark is written, read by an image reading unit (scanner) of the printer 10 that is not shown in the figure. When the predetermined mark is written in the ID photo printing check box CB of the order sheet OS read by the image reading unit, the printer 10 prints an ID photo having the front face of the target image corresponding to the ID photo printing check box CB in which the mark is written.

When printing the order sheet OS, the printer 10 does not need to print both the ID photo printing mode UI and the ID photo printing check box CB for the target image having a front face and may be configured to print any one of them. For example, a configuration in which a user writes a predetermined mark in a design of the ID photo printing mode UI that is printed on a printing medium with a pen or the like, and the image reading unit reads out the written mark from the design may be used.

Next, a technique other than the technique using the neural network NN in a front-face image detecting process that is performed by the face image detecting unit 20 in S200 will be described.

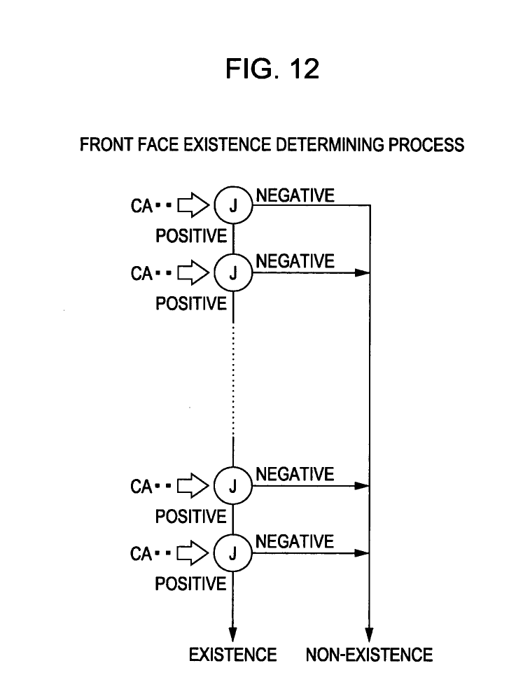

FIG. 12 schematically shows an example of the front-face existence determining process that is performed by the face image detecting unit 20. The face image detecting unit 20 may be configured to perform the front-face existence determining process shown in FIG. 12 by replacing S230 to S250 (FIG. 3). In this front-face existence determining process, a determination unit formed by connecting a plurality of determinators J, J . . . in a cascade pattern for forming a plurality of stages is used. Here, the determination unit that is formed of the plurality of determinators J may be a physical device or a program that has determination functions described below corresponding to the plurality of determinators J. Each determinator J, J . . . receives one or a plurality of characteristic amounts CA, CA, CA . . . of different types (for example, filters FT are different) from the window image data XD as input and outputs positive determination or negative determination. Each determinator J, J . . . includes a determination algorithm for comparing the characteristic amounts CA, CA, CA . . . , determining a threshold value, or the like and performs independent determination on whether the window image data XD is like a front face (positive) or unlike a front face (negative). Each determinator J, J . . . of the next stage is connected to the positive output of the determinator J, J . . . of the previous stage. Thus, each determinator J, J . . . of the next stage performs determination only when the output of the determinator J, J . . . of the previous stage is positive. In any stage, at a time point when the negative output is made, the determination process ends, and determination of non-existence of a front face is output (in this case, the face image detecting unit 20 proceeds to S270). On the other hand, when all the determinators J, J . . . of each stage have positive output, the determination process ends, and determination of existence of a front face is output (in this case, the face image detecting unit 20 proceeds to S260).

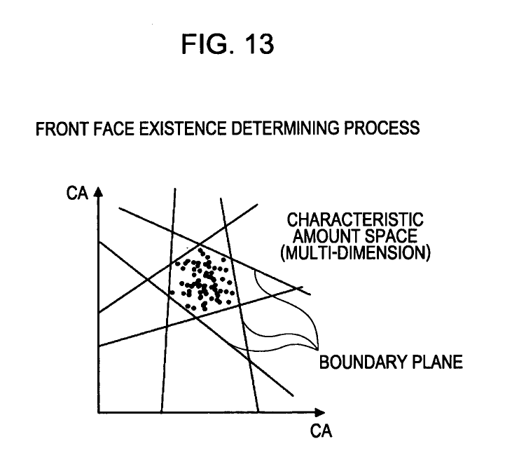

FIG. 13 shows determination characteristics of the determination unit. In the figure, a characteristic amount space defined by axes of the characteristic amounts CA, CA, CA . . . that are used in the above-described determinators J, J . . . is shown. In the figure, coordinates in the characteristic amount space which are represented by combinations of the characteristic amounts CA, CA, CA . . . that are acquired from the window image data XD in which a front face is finally determined to exist are plotted. The window image data XD in which a front face is determined to exist has a specific characteristic and thus, can be considered to be distributed in a specific area in the characteristic amount space. Each determinator J, J . . . generates a boundary plane in the characteristic amount space. Then, when the coordinates of the characteristic amounts CA, CA, CA . . . for determination exist in the space belonging to the distribution within the space partitioned by the boundary plane, each determinator J, J . . . outputs positive. Accordingly, by connecting the determinators J, J . . . in a cascade pattern, the space for positive output can be decreased gradually. By using a plurality of the boundary planes, determination can be made with high accuracy for a distribution having a complicated shape.

As above, an example in which the face image-output control device and the method of controlling output of a face image according to embodiments of the invention are implemented as the printer 10, and the program for controlling output of the face image is executed in cooperation with the printer 10 has been shown. However, the invention may be implemented in an image-output process by using an image device such as a computer, a digital still camera, a scanner, or a photo viewer. For the determination process of the face image detecting unit 20, various determination techniques using the characteristic amounts in the above-described characteristic amount space may be used. For example, a support vector machine may be used.

The present application claims the priority based on a Japanese Patent Application No. 2008-084249 filed on Mar. 27, 2008, the disclosure of which is hereby incorporated by reference in its entirety.

What is claimed is:

1. A face image-output control device comprising:
a face image detecting unit that detects a face image positioned in an approximately front direction from a target image; and
an output control unit that outputs the target image and a predetermined mark indicating that a face image of the target image can be printed as an identification photograph to a predetermined output target for a case where the face image positioned in an approximately front direction is detected by the face image detecting unit.

2. The face image-output control device according to claim 1, wherein the output control unit selects one face image from among a plurality of detected face images based on a predetermined reference and outputs a predetermined mark indicating that the selected face image can be printed as an identification photograph in a case where the plurality of face images positioned in an approximately front direction is detected by the face image detecting unit.

3. The face image-output control device according to claim 2, wherein the output control unit selects one face image, which has a maximum size, from among the plurality of face images positioned in an approximately front direction which are detected by the face image detecting unit.

4. The face image-output control device according to claim 1, wherein the output control unit outputs the target image and the predetermined mark in a predetermined screen and outputs a trimming frame that defines a trimming range on the target image and can be moved, enlarged, or reduced in accordance with an external operation to the screen for a case where selection of a predetermined mark is received.

5. The face image-output control device according to claim 1, wherein the output control unit prints the target image and the predetermined mark on a printing medium.

6. The face image-output control device according to claim 1, wherein the face image detecting unit performs the detection by using a neural network that receives information on an image within a detection window that is set in the target image and outputs information indicating existence or non-existence of a face image positioned in an approximately front direction.

7. A method of controlling output of a face image, the method comprising using a processor to perform the operation of:
detecting a face image positioned in an approximately front direction from a target image; and
outputting the target image and a predetermined mark indicating that a face image of the target image can be printed as an identification photograph to a predetermined output target for a case where the face image positioned in an approximately front direction is detected in the detecting of a face image.

8. A computer program for image processing embodied on a computer-readable medium that allows a computer to perform functions including:
a face image detecting function for detecting a face image positioned in an approximately front direction from a target image; and
an output control function for outputting the target image and a predetermined mark indicating that a face image of the target image can be printed as an identification photograph to a predetermined output target for a case where the face image positioned in an approximately front direction is detected in the detecting of a face image.

9. A printing device comprising:
a face image detecting unit that detects a face image positioned in an approximately front direction from a target image; and
an output control unit that outputs the target image and a predetermined mark indicating that a face image of the target image can be printed as an identification photograph to a predetermined output target for a case where the face image positioned in an approximately front direction is detected by the face image detecting unit.
